(19) United States
(12) Patent Application Publication
(10) Pub. No.: US 2008/0115777 A1
(43) Pub. Date: May 22, 2008

(54) Barbeque with gas jet burner

(76) Inventor: Huang-Hsi Hsu, Taipei (TW)

Correspondence Address: BACON & THOMAS, PLLC, 625 SLATERS LANE, FOURTH FLOOR, ALEXANDRIA, VA, 22314, US

(21) Appl. No.: 11/600,095

(22) Filed: Nov. 16, 2006

(51) Int. Cl. F24C 3/12; A47J 37/07; F24C 3/08

(52) U.S. Cl. 126/42; 126/25 R; 126/39 E

(57) ABSTRACT

The present invention is to provide a barbeque comprising a hollow body having an internal for containing fuel (e.g., charcoal), a container disposed externally of the body and having an internal receiving space, and a hose having one end connected to a surface of the body and the other end connected to a gas jet burner. In use, a user can align the gas jet burner with the fuel contained in the hollow body prior to activating the gas jet burner to shoot flame onto the fuel for ignition. After use, the user can securely place the gas jet burner in the internal receiving space for storage. By utilizing this barbeque, the hot portion of the gas jet burner is isolated from the external so as to prevent the user from being burned by inadvertently touching the hot gas jet burner, resulting in a great increase of operating safety.

### FIELD OF THE INVENTION

The present invention relates to barbeques and more particularly to a barbeque having a gas jet burner with improved characteristics including safety and free of clogging.

### BACKGROUND OF THE INVENTION

People are willing to spend more time on leisure activities and enjoy same as time evolves. Thus, barbeque is gaining popularity among people since it is an activity suitable for the participation of all family members, relatives and friends. However, many ugly, not user-friendly, and impractical barbeques are still commercially available in the market. For example, there are two types of barbeque of substantially the same reasonable price available. It is understood that one type of barbeque favored by a person must have the features of being more user-friendly and practical as compared with the other type of barbeque. It is also understood that the barbeque market is very competitive. Hence, some manufacturers of the barbeque will be eliminated out of the market if they do not produce barbeques having the features of being more user-friendly and practical as compared with the barbeques manufactured by other barbeque manufacturers.

A conventional barbeque 11 is shown in FIG. 1. The barbeque 11 operates in cooperation with a gas jet burner 13 by connecting a flexible tube (e.g., hose) 12 therebetween as detailed below. The barbeque 11 is bowl-shaped and comprises a circular opening 111 on a circumferential surface. A space 113 is defined by the barbeque 11. The space 113 communicates with the external through the opening 111. The flexible tube 12 has one end connected to another opening on the circumferential surface of the barbeque 11 and the other end connected to the gas jet burner 13. The flexible tube 12 is adapted to bend. For example, a user may bend the flexible tube 12 toward the opening 111 in order to insert a gas inlet jet 131 of the gas jet burner 13 through the opening 111 into the space 113. Flame is shot out of the gas inlet jet 131 onto charcoal or piles of wood contained in the space 113 when the gas jet burner 13 activates. Alternatively, the user may bend the flexible tube 12 toward a top of the barbeque 11 in order to cause the gas inlet jet 131 to face the space 113. Likewise, flame is shot out of the gas inlet jet 131 onto charcoal or piles of wood contained in the space 113 when the gas jet burner 13 activates. In such a manner, charcoal or piles of wood contained in the space 113 can be quickly ignited by the gas jet burner 13.

However, the prior art suffered from a number of disadvantages. For example, it is possible that the gas inlet jet 131 may pull out of the opening 111 by inadvertently pushing the gas jet burner 13 when flame is shooting out of the gas inlet jet 131, which is inserted through the opening 111 into the space 113, onto charcoal or piles of wood contained in the space 113. It is often that the flame shoots out of the gas inlet jet 131 onto the user standing by the barbeque 11 inadvertently. As a result, the user is hurt. Moreover, the gas inlet jet 131 cools down when the gas jet burner 13 is deactivated. However, after use it is highly possible that the user may be burned by inadvertently touching the hot gas inlet jet 131 since the gas jet burner 13 hanging on the barbeque 11 is simply supported by the flexible tube 12. In addition, cooked food or grease may clog the mouth of the gas inlet jet 131 after a period time of use. As an end, the gas inlet jet 131 malfunctions. Thus, it is desirable among manufacturers of the art to provide a novel barbeque having an improved gas jet burner in order to overcome the inadequacies of the prior art.

### SUMMARY OF THE INVENTION

After considerable research and experimentation, a barbeque having a gas jet burner according to the present invention has been devised so as to overcome the above drawbacks including unsafe operation of the prior art.

It is an object of the present invention to provide a barbeque comprising a hollow body, a container, a hose, and a gas jet burner. The body has an internal for containing fuel (e.g., charcoal). The container is disposed externally of the body and has an internal receiving space. The hose has one end connected to a surface of the body and the other end connected to the gas jet burner. In use, a user can align the gas jet burner with the fuel contained in the space prior to activating the gas jet burner to shoot flame onto the fuel for ignition. After use, the user can securely place the gas jet burner in the receiving space for storage. By utilizing this barbeque, the hot portion of the gas jet burner is isolated from the external so as to prevent the user from being burned by inadvertently touching the hot gas jet burner, resulting in a great increase of operating safety.

The above and other objects, features and advantages of the present invention will become apparent from the following detailed description taken with the accompanying drawings.

### BRIEF DESCRIPTION OF THE DRAWINGS

FIG. 1 is a perspective view of a portion of a conventional barbeque to be mounted with a gas jet burner;

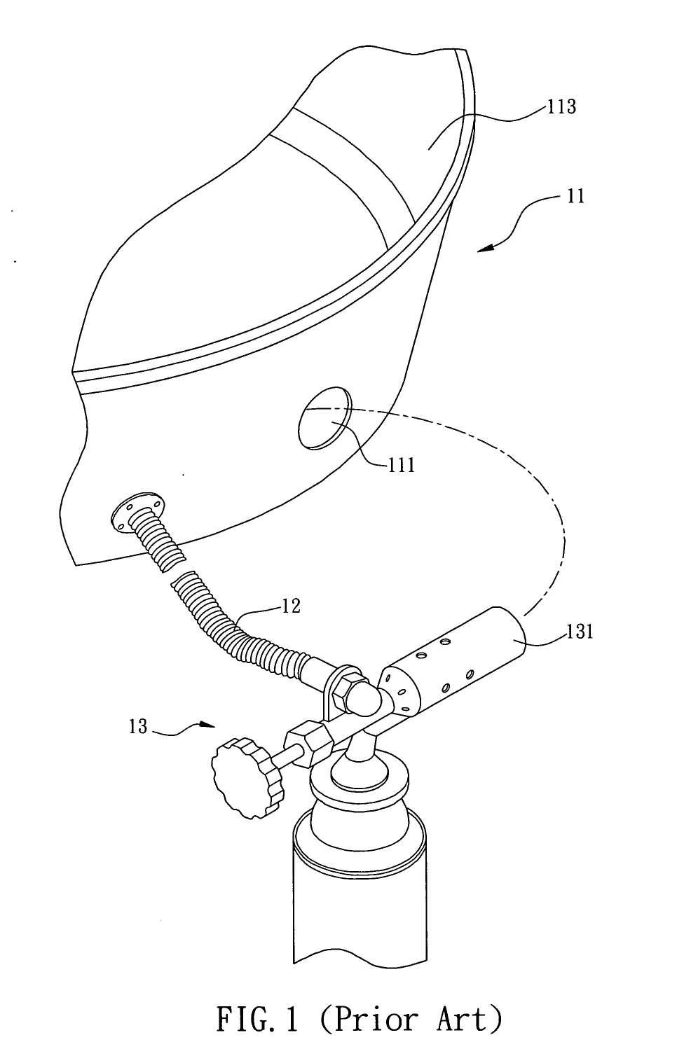

FIG. 2 is a perspective view of a barbeque having a gas jet burner according to the invention in one operating configuration;

FIG. 3 is a side view in part section of a portion of the barbeque and the gas jet burner mounted thereon in another operating configuration; and

FIG. 4 is an exploded perspective view of the external container of the barbeque, the hose, the gas jet burner, the fastening element, and the bracket according to the invention.

### DETAILED DESCRIPTION OF THE PREFERRED EMBODIMENTS

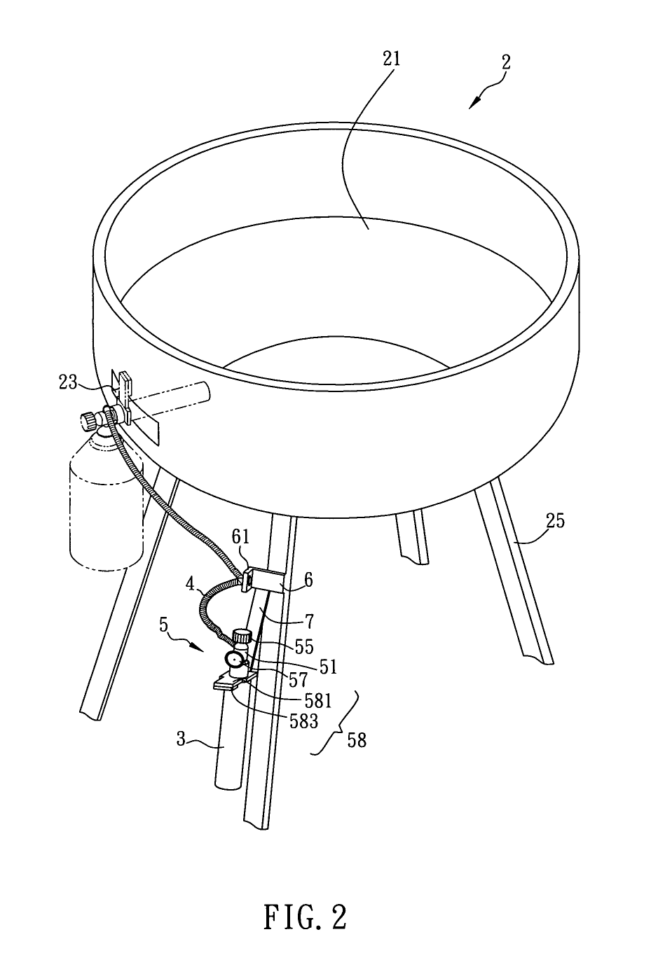

Referring to FIGS. 2 to 4, a barbeque in accordance with the invention comprises a bowl-shaped body 2, a container 3, a hose 4, and a gas jet burner 5. Each component is discussed in detailed below.

A space 21 is defined by the body 2. The container 3 is affixed to one of a plurality of legs 25 of the body 2. The cylindrical container 3 has a closed bottom and an open top with a receiving space 31 defined therein. The hose 4 has one end connected to an opening on the circumferential surface of the body 2 and the other end connected to the gas jet burner 5. In use, a user may hold and move the gas jet burner 5 into the space 21. Next, activate the gas jet burner 5 to shoot flame onto fuel (e.g., charcoal or piles of wood (not shown)) contained in the space 21. As a result, the fuel is ignited. After use, the user may place the gas jet burner 5 in the receiving space 31 for storage. The hot portion of the gas jet burner 5 is isolated from the external by the receiving space 31 so as to prevent the user from being burned by inadvertently touching the hot gas jet burner 5. This can greatly increase safety in using the barbeque.

Referring to FIG. 2 again, in a first preferred embodiment of the invention the body 2 further comprises an opening 23 on a circumferential surface. The space 21 communicates with the external through the opening 23. A gas inlet jet 53 of the gas jet burner 5 is inserted through the opening 23 into the space 21 to be proximate the fuel (not shown). This is contrary to holding the gas jet burner 5 above the space 21 by the hand in cooking food. Thus, it is possible of preventing a user from being burned by hot gases rising from the space 21 while cooking.

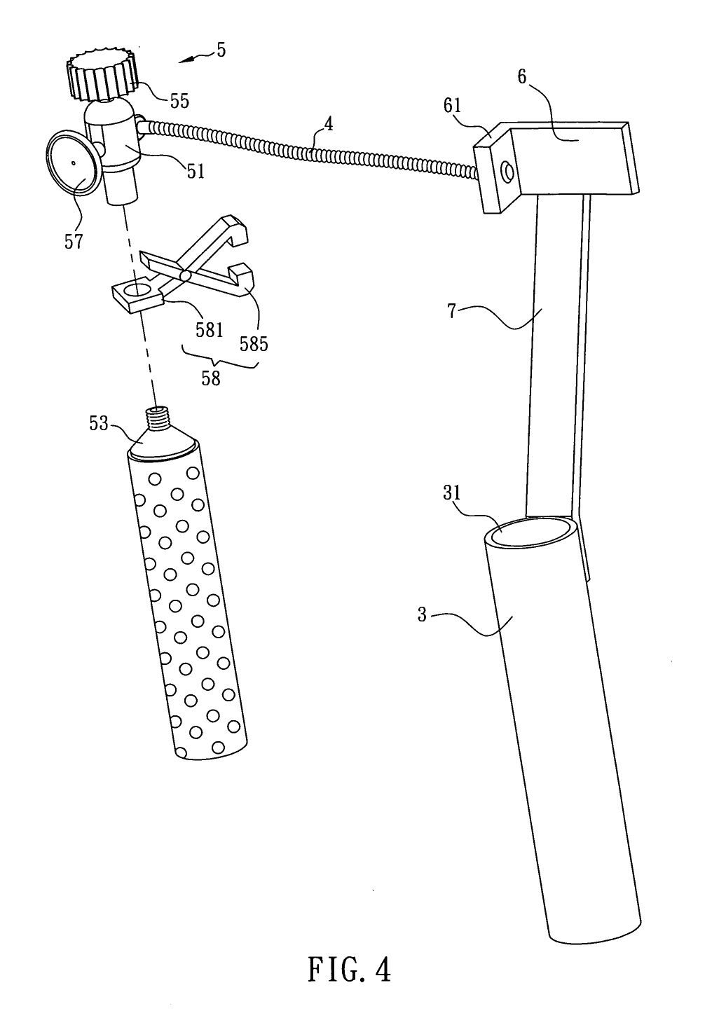

Referring to FIGS. 2 and 4 again, in the first preferred embodiment a plate 6 and a bracket 7 are provided to interconnect the body 2 and the container 3. The L-shaped plate 6 has a straight portion affixed to the leg 25 of the body 2. The straight portion of the plate 6 has its bottom connected to an upper end of the slanting bracket 7. A lower end of the bracket 7 is connected to the container 3. Thus, the container 3 is disposed externally of and is spaced from the body 2 by a predetermined distance. This can prevent high heat generated by burning fuel contained in the body 2 from transferring to the container 3 by conduction. Further, this can prevent the hand of a user from being burned by inadvertently touching the body 2 when pulling the gas jet burner 5 out of the receiving space 31.

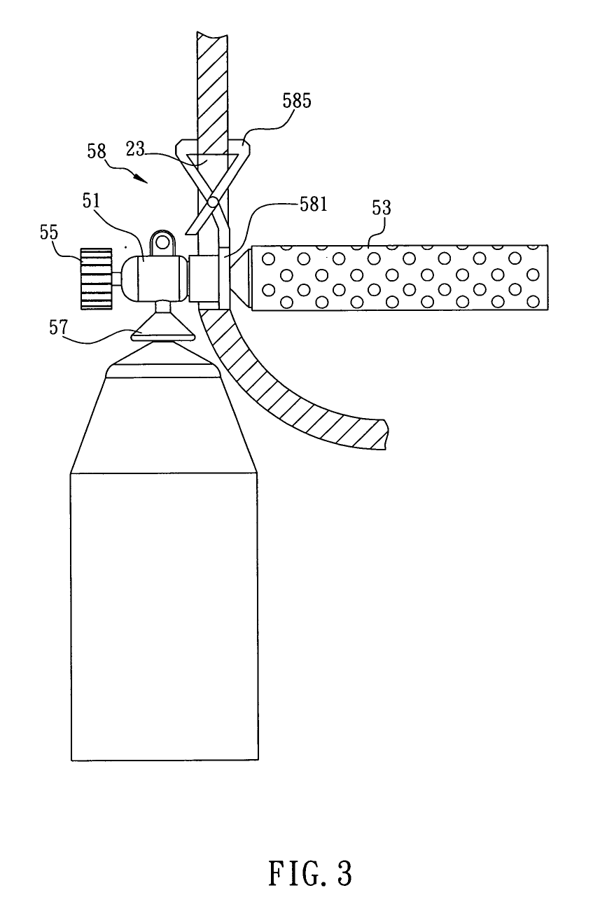

Referring to FIGS. 2 and 3 again, in the first preferred embodiment the gas jet burner 5 comprises a gas control valve 51, a gas inlet jet 53, a control knob 55, and a connector 57. One side of the gas control valve 51 is connected to the other end of the hose 4 and is in fluid communication therewith. The gas inlet jet 53 is extended from one end of the gas control valve 51. The gas inlet jet 53 is disposed in the receiving space 31 when the gas jet burner 5 is placed in the container 3. The gas inlet jet 53 is inserted through the opening 23 into the space 21. The control knob 55 is disposed externally of the other end of the gas control valve 51 opposite the gas inlet jet 53. The connector 57 is interconnected the other side of the gas control valve 51 and a gas bottle and is in fluid communication with both. In use, a user may turn the control knob 55 to open the gas control valve 51. Thus, gas contained in the gas bottle quickly flows through the gas control valve 51 to the gas inlet jet 53. As an end, flame is shot out of the gas inlet jet 53.

Referring to FIGS. 2 and 3 again, in the first preferred embodiment the gas jet burner 5 further comprises a fastening element 58 including a mounting member 581 and a magnetic member 583. The mounting member 581 is provided between the gas inlet jet 53 and the gas control valve 51. The magnetic member 583 is provided on a bottom of the mounting member 581. The magnetic member 583 is adhered to the body 2 proximate the opening 23 when the gas inlet jet 53 passes the opening 23 into the space 21. As such, the gas jet burner 5 is mounted and is secured to the opening 23. By configuring as above, it is possible of preventing the gas inlet jet 53 from disengaging with the opening 23 by inadvertently pushing the gas jet burner 5. Therefore, it is possible of preventing flame shot out of the gas inlet jet 53 from burning the user standing by the body 2.

Referring to FIGS. 2 and 4 again, in a second preferred embodiment of the invention the gas jet burner 5 further comprises a fastening element 58 including a mounting member 581 and a pair of pivotal jaws 585. The mounting member 581 is put on a neck between the gas inlet jet 53 and the gas control valve 51. The jaws 585 are opposite the mounting member 581 at one end of the gas control valve 51. The gas inlet jet 53 passes the opening 23 to extend into the space 21. The jaws 585 clamp two opposite portions of the opening 23 on the circumferential surface of the body 2. As such, the gas jet burner 5 is mounted and is secured to the opening 23. By configuring as above, it is possible of preventing the gas inlet jet 53 from disengaging with the opening 23 by inadvertently pushing the gas jet burner 5. Therefore, it is possible of preventing flame shot out of the gas inlet jet 53 from burning the user standing by the body 2.

Referring to FIG. 2 again, in the preferred embodiments a plurality of legs (four are shown) 25 are extended downward from the bottom of the body 2. Thus, the body 2 is supported above a supporting ground by a predetermined distance by the legs 25. This can greatly reduce high heat generated by the burning fuel from transferring to the supporting ground by conducting through the legs 25. Further, the plate 6 is adapted to mount on any one of the legs 25 so as to further dispose the container 3, the gas jet burner 5, and the gas bottle away from the body 2. As a result, operating safety is greatly increased.

Referring to FIG. 2 again, in the preferred embodiments the plate 6 further comprises a bending portion 61 formed with one end of its straight portion. One end of the hose 4 is connected to the bending portion 61. Thus, the plate 6, the fastening element 7, the container 3, the hose 4, and the gas jet burner 5 are assembled together. A user may use the plate 6 to quickly assemble the fastening element 7, the container 3, the hose 4, and the gas jet burner 5 either at a desired position of the body 2 or at any type of barbeque. Further, its disassembly is easy, resulting in a great increase of the flexibility of the barbeque.

While the invention herein disclosed has been described by means of specific embodiments, numerous modifications and variations could be made thereto by those skilled in the art without departing from the scope and spirit of the invention set forth in the claims.

What is claimed is:

1. A barbeque comprising:
a hollow body having a space defined therein;
a hose having one end connected to a surface of the body;
a gas jet burner connected to the other end of the hose; and
a container disposed externally of the body and having a receiving space defined therein for receiving the gas jet burner.

2. The barbeque of claim 1, wherein the body further comprises an opening on the surface such that the space is adapted to communicate with the external through the opening.

3. The barbeque of claim 2, further comprising:
a plate disposed externally of the body; and
a bracket disposed externally of the body and having one end connected to the plate and the other end connected to the container.

4. The barbeque of claim 3, wherein the gas jet burner comprises:
a gas bottle;
a gas control valve having one side connected to the other end of the hose and being in fluid communication therewith;
a gas inlet jet extended from one end of the gas control valve;
a control knob disposed externally of the other end of the gas control valve opposite the gas inlet jet; and
a connector interconnected the other side of the gas control valve and the gas bottle and being in fluid communication with both.

5. The barbeque of claim 4, wherein the gas jet burner further comprises a fastening element including:
a mounting member mounted between the gas inlet jet and the gas control valve; and
a magnetic member mounted on a bottom of the mounting member wherein the magnetic member is adhered to the body proximate the opening when the gas inlet jet passes the opening to extend into the space.

6. The barbeque of claim 4, wherein the gas jet burner further comprises a fastening element including:
a mounting member mounted between the gas inlet jet and the gas control valve; and
a pair of pivotal jaws opposite the mounting member at one end of the gas control valve wherein the jaws clamp two opposite portions of the opening on the surface of the body when the gas inlet jet passes the opening to extend into the space.

7. The barbeque of claim 5, wherein the body further comprises a plurality of legs extended downward from a bottom.

8. The barbeque of claim 6, wherein the body further comprises a plurality of legs extended downward from a bottom.

9. The barbeque of claim 7, wherein the plate is mounted on one of the legs and has a bending portion formed at one end.

10. The barbeque of claim 8, wherein the plate is mounted on one of the legs and has a bending portion formed at one end.

11. The barbeque of claim 9, wherein one end of the hose is connected to the bending portion.

12. The barbeque of claim 10, wherein one end of the hose is connected to the bending portion.
